(19) United States
(12) Patent Application Publication
(10) Pub. No.: US 2002/0060822 A1
(43) Pub. Date: May 23, 2002

(54) Method of improving the signal quality of optical signals, transmission system and also a modulator

(75) Inventor: Berthold Wedding, Korntal-Munchingen (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/988,168

(22) Filed: Nov. 19, 2001

(30) Foreign Application Priority Data
Nov. 23, 2000 (DE) 100 58 262.1

(51) Int. Cl. H04J 14/02; H04B 10/00

(52) U.S. Cl. 359/124; 359/156

(57) ABSTRACT

A method of improving the signal quality of optical signals and also a transmission system for transmitting optical signals with FEC are proposed. In this connection, transmission system, transmitter and method operate with a polarization modulator that modulates the optical signal at the transmitter end.

### BACKGROUND OF THE INVENTION

The invention is based on a priority application 100 58 262.1 which is hereby incorporated by reference.

A method of improving the signal quality of optical signals and also a transmission system for the transmission of optical signals and a modulator according to the generic kind of the independent claims are proposed.

For the optical transmission of high-bit-rate signals, which involves data rates of 10 Gbit/s to 40 Gbit/s, limitations are observed that are due to the physical properties of the transmission fibres. Problems due to attenuations and chromatic dispersion are overcome by the use of fibre amplifiers, of dispersion-shifted fibres and dispersion compensation techniques. Yet even if monomode fibres are used, the polarization mode dispersion (PMD) effect remains unimpaired as a limiting effect for fibre length and data rate. The PMD has a birefringent effect that, in a first order, results in a propagation of the signal over two different paths and consequently to signal distortion.

In this connection, one parameter for describing the distortions due to PMD is relative powers γ and 1-γ of the signals allotted to the fast and the slow main axes of the birefringent fibre. The second parameter is the differential delay between the group velocities (DGD=differential group delay) Δτ.

The dispersion due to PMD is of a random nature and changes with time. Different ambient temperatures, in particular, result in a fluctuation in the PMD. In order to obtain signals that can be evaluated despite these dispersion effects, the most varied types of PMD compensation or filtering are used in optical signal receivers.

For example, the review article “Equalization of Bit Distortion Induced by Polarization Mode Dispersion” by H. Bülow, NOC '97, Antwerp, pages 65 to 72, describes a multiplicity of ways of making it possible to compensate for polarization mode dispersion. One way of solving the problems relating to polarization mode dispersion is to operate a polarization controller in the receiver and to adjust the polarization of the optical signal adaptively to the polarization dispersion of the transmission link. In that case, the information about the polarization dispersion of the transmission link takes place via a return channel. Such a polarization control is expensive and has to be implemented separately for every optical signal in a wavelength. It is precisely that that presents problems if the optical signal is a wavelength-division multiplex signal. It is precisely in high-bit-rate data transmission systems that the signals are frequently composed of different wavelength signals. This WDM (wavelength division multiplex) method makes possible the transmission of data that are transmitted on a number of modulated optical carriers whose frequencies differ. It is precisely in such a case in which a plurality of lasers operating independently of one another operate as sources of the optical signal in parallel with one another that an active adjustment of the polarization plane of the individual signals is no longer possible.

U.S. Pat. No. 5,841,557 discloses a method of altering the polarization of signals in a WDM system. The method operates with a scrambling frequency of bit/2 so that the polarization state is altered for every transmitted bit. This method prevents adjacent channels having an identical polarization from being subjected to a four-wave mixing and thus from being disturbed. The object is not to minimize PMD.

### SUMMARY OF THE INVENTION

The inventive method and also transmission system have by contrast the advantage that no active adjustment of the transmission system to the problems of polarization mode dispersion takes place, but that the polarization mode dispersion effects are distributed by modulation of the polarization plane—that is to say modulation randomly distributed in such a way that a better transmission behaviour can be achieved when averaged over all the optical signals to be transmitted. In this connection, it is advantageous that, with a particular polarization position of the signal and a particular polarization mode dispersion, the transmission system results in very high bit error rates and is pulled out of this state by the modulation. On the other hand, the system may have polarization states in which the system operates virtually error-free. The modulation prevents the system remaining in a very negative transmission state, whereas remaining in a positive transmission state is in turn limited in time. As a result of the modulation, a better random distribution of positive and negative transmission behaviour of the optical signal is seen over time.

Furthermore, it is advantageous to use an FEC (forward error correction) method in the transmission system. The FEC method reduces the bit error rate in WDM transmission systems by adding redundant information, such as, for example, individual code bits, to the items of information in the individual optical channels. At the receiver end, a decoder examines the code bits in order to be able to reconstruct the transmitted information exactly. A multiplicity of different algorithms, such as Viterbi algorithms, Reed-Solomon, are known.

It is precisely in the combination of the bit-error rates occurring in the short term as a result of the modulation with a FEC algorithm that particularly advantageous transmission values can be achieved. In this connection, the polarization state of the optical signal is advantageously modulated at a frequency that is less than the bit rate or is situated in the region of the FEC frame frequency. In order to improve the transmission system and the method still further, PMD equalizers can be used in the receiver that are able to track the frequency of the modulation.

Modulators for modulating polarization γ are disclosed in U.S. Pat. No. 5,930,414. A polarization modulator based on a Mach-Zehnder structure is used.

### BRIEF DESCRIPTION OF THE DRAWINGS

A possible embodiment of the invention is described in the drawings and explained in greater detail in the description below.

In the drawing:

FIG. 1 shows a WDM transmission system.

FIG. 1 shows a complete transmission system for optical signals. A transmitter 1 is connected to a transmission link 8. The transmission link 8 terminates at a receiver 12. The electrical input signal is first applied to an FEC unit 6. The electrical signal at the output of the FEC unit 6 is applied to the input of the electro-optical converter 2. The output of the electro-optical converter 2 is applied to the input of the wavelength multiplexer 3. The output of the wavelength multiplexer is connected, in this exemplary embodiment, to an amplifier 7. The latter is connected in turn to a polarization modulator 4 and a further amplifier 7. The polarization modulator 4 is connected to a generator 5 for the modulation frequency. The signal of the amplifier 7 travels via the transmission link 8. A further polarization modulator 4 may be incorporated within the transmission link. The “in-line” polarization modulator acts in conjunction with the DGD of the transmission link like a DGD modulator.

The signal is applied to the input of a receiver 12. In this case, an amplifier 7 is again the first input stage. The output of the amplifier 7 is connected to a wavelength demultiplexer 9 whose outputs are each applied to an input of an opto-electrical converter 10. The outputs of the opto-electrical converter 10 are connected to FEC regenerators 11.

To transmit the optical signals in such a transmission system, the polarization of the optical signal, for example a 10 Gbit/s signal, is modulated with a high frequency. The modulation frequency is, for example, 160 MHz. A transmission system involving polarization mode dispersion may prove particularly susceptible to faults under certain circumstances. A case may occur, for example, in which the differential group delay time is exactly one bit period and the power in the two mutually orthogonally polarized modes is precisely the same. In such cases, even the use of an FEC method cannot ensure good results in recovering the signal. As a result of modulating the polarization, the system is “modulated out of” such a state. The polarization of the optical signal is modulated with a high frequency. Said frequency should be high enough for the bit errors to be capable of being corrected by an FEC method. As a result of modulating with the high frequency and averaging over the polarization mode dispersion, bit error rates occur in a short time scale. The resultant bit error rate can then be reduced further by an FEC method. The behaviour of the transmission system is improved with respect to an unmodulated system as a result of the averaging effect.

A further improvement is achieved by using a PMD equalizer in the receiver 12. This filter is implemented as electronic filter 13, such as that described, for example, in German Application 199 36 254.8 or 100 13 790.3. The electronic equalizer 13 is shown by way of example outside the opto-electrical converter 10. In another embodiment, the equalizer is incorporated in the opto-electrical converter itself. If an electronic PMD filter is used, it is necessary to ensure that the response time of the filter is fast enough to track the modulation of the polarization.

In a further embodiment, an optical PMD filter is used in the receiver 12 upstream of the opto-electrical conversion. A further embodiment uses, in receiver 12, first an optical PMD filter before the optical signal is converted and an electronic PMD equalizer after the conversion.

A further improvement is achieved by using an “error-and-erasure” algorithm. This known algorithm in combination with a fast filter 13 makes it possible to double the length of an error burst and increases the PMD tolerance of the optical receiver. Suitable as filter 13 is, for example, an embodiment of the transversal equalizer according to DE 199936254.8. Said filter supplies items of information for the application of the error-and-erasure method derived from the control parameters of the filter 13. The filter has to supply items of information about the position of the error in the signal in order to support the subsequent stage of error-and-erasure processing of the signal.

The electrical signal 20 present at the input side is converted in the electro-optical converter 2 into an optical signal 21. Said optical signal 21 has a certain polarization state. A laser diode that is either modulated directly or whose light passes through an external modulator serves as electro-optical converter.

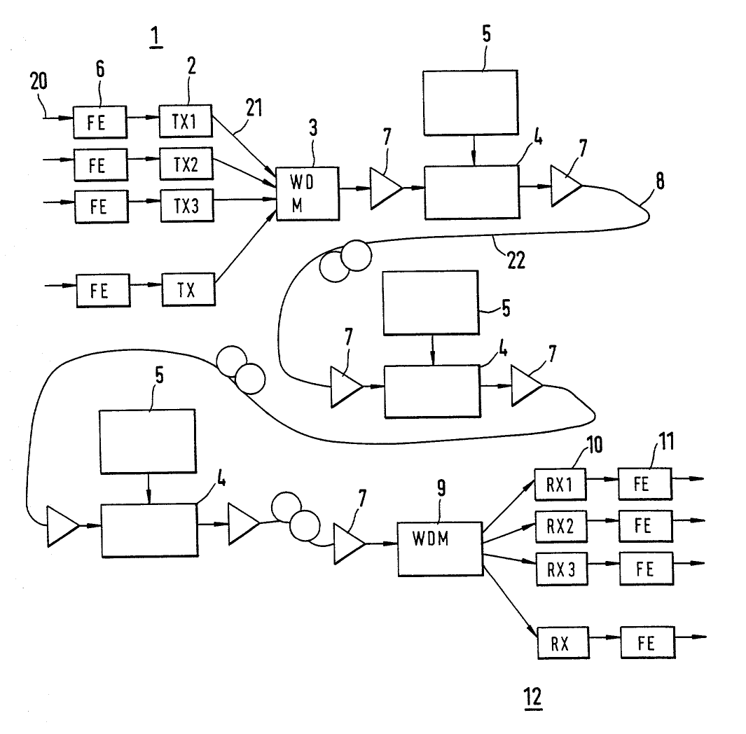

A transmitter in the embodiment of FIG. 1 serves for use in a wavelength-division multiplex. A plurality of electro-optical converters is used. Said electro-optical converters 2 convert electrical input signals 20 into optical signals 21 of different wavelength. The optical input signals are applied to a wavelength multiplexer 3. The output signal 23 of the wavelength multiplexer 3 contains all the items of information of the various wavelength channels. This signal, which contains various polarization states of the different electro-optical converters 2, is then modulated in polarization modulator 4 in its polarization states y. The modulated optical signal 21 is passed to the transmission link. It is precisely for such a wavelength-division multiplex transmission method that it is of importance that the system does not remain in a polarization state for a channel in which high bit-error rates are generated. Under certain circumstances, this may result in a total failure of a wavelength channel. As a result of the modulation, this channel is set to polarization states whose transmission properties result in marked improvements in the bit-error rates.

To design a transmission system, it is necessary to adapt the individual components. The form described in FIG. 1 is an exemplary solution in which a certain combination of components does not have to exist for the application of the inventive idea.

1. Transmission system for the transmission of optical WDM signals via transmission links comprising transmitters and receivers, in which an FEC encoding takes place at the transmitter end and is decoded at the receiver end and in which the optical signal passes through at least one polarization modulator in order to modulate the signal.

2. Transmission system according to claim 1, wherein the receiver comprises filters for compensating for PMD effects.

3. Modulator for modulating an optical signal in a WDM transmission system comprising a polarization modulator that is connected to a generator having a permanently tuneable frequency, wherein the frequency of the generator is determined by the error correction method.

4. Modulator according to claim 3 incorporated at the transmitter end.

5. Modulator according to claim 3 incorporated in the transmission link.

6. Modulator according to claim 3 connected to at least one further modulator.

7. Method of improving the signal quality of optical signals that are distorted owing to polarization mode dispersion, wherein the optical signal is modulated in its polarization direction with a frequency suited to the error correction method.

8. Receiver for use in a transmission system according to claim 1, wherein the receiver contains demultiplexers, optical receivers, filters and FEC regenerators.

9. Receiver according to claim 11, wherein error-and-erasure regenerators are connected to equalizers.

10. Receiver according to claim 11, wherein electronic filters at least track the frequency of the polarization changes in the modulators.
